(19) United States
(12) Patent Application Publication
(10) Pub. No.: US 2023/0083021 A1
(43) Pub. Date: Mar. 16, 2023

(54) SURVEYING DATA PROCESSOR, SURVEYING DATA PROCESSING METHOD, AND SURVEYING DATA PROCESSING PROGRAM

(71) Applicant: TOPCON CORPORATION, Tokyo (JP)

(72) Inventor: You SASAKI, Tokyo (JP)

(73) Assignee: TOPCON CORPORATION, Tokyo (JP)

(21) Appl. No.: 17/929,316

(22) Filed: Sep. 2, 2022

(30) Foreign Application Priority Data
Sep. 13, 2021 (JP) 2021-148616

(51) Int. Cl. G01S 17/66; G01C 15/06; B64C 39/02

(52) U.S. Cl. CPC G01S 17/66; G01C 15/06; B64C 39/024; B64C 2201/122

(57) ABSTRACT

Information of an instrument point of a surveying apparatus is more simply and easily acquired. Positioning data that is obtained by a first surveying apparatus in which exterior orientation parameters are known, and positioning data that is obtained by a second surveying apparatus in which exterior orientation parameters are unknown, are received. The first surveying apparatus and the second surveying apparatus are configured to obtain positioning data by measuring multiple positions of a UAV that is flying. A piece of positioning data is acquired from the positioning data of the UAV obtained by the first surveying apparatus and from the positioning data of the UAV obtained by the second surveying apparatus. These pieces of positioning data are in a correspondence relationship. The position of the second surveying apparatus is calculated based on the pieces of positioning data that are in the correspondence relationship, by a method of resection.

### CROSS-REFERENCE TO RELATED APPLICATIONS

This application claims priority to Japanese Patent Application No. 2021-148616, filed Sep. 13, 2021, the disclosure of which is incorporated herein by reference in its entirety.

### FIELD

The present invention relates to a technique for use in setting up a surveying apparatus.

### BACKGROUND

In using a surveying apparatus, such as a total station (TS), the set-up position of the surveying apparatus should be determined. Specifically, it is necessary to obtain data of the position of a surveying apparatus in a coordinate system to be used. This is a basic matter in surveying operations. This position of a surveying apparatus is also called a “mechanical position” or an “instrument point”. The operation to obtain the position is called “obtaining of an instrument point”, “setting up of an instrument point”, etc.

Classical methods include a method of surveying an instrument point at an unknown position by using a surveying apparatus at a known position. Another method of measuring a position of an instrument point by relative positioning using a GNSS may also be used. In yet another example, Japanese Unexamined Patent Application Publication No. 2017-203742 discloses a technique of calculating a position of an instrument point by using a three-dimensional model.

The method of measuring a position of an instrument point by using a surveying apparatus can be employed on the condition that the instrument point is able to be viewed from the surveying apparatus. On the other hand, the method employing relative positioning using a GNSS is limited in use due to the need for a dedicated device and the need to obtain information from a control station. Moreover, for a mountainous region or the like, the method using a GNSS has a limitation in the navigation satellites that can be used, resulting in low accuracy of positioning, in some cases. The method of using a three-dimensional model requires a three-dimensional model that is prepared in advance.

### SUMMARY

In view of these circumstances, an object of the present invention is to provide a technique that enables more simply and easily acquiring information of an instrument point of a surveying apparatus.

An aspect of the present invention provides a surveying data processor including a processor or circuitry. The processor or circuitry is configured to receive positioning data that is obtained by a first surveying apparatus in which exterior orientation parameters are known, and receive positioning data that is obtained by a second surveying apparatus in which exterior orientation parameters are unknown. The first surveying apparatus and the second surveying apparatus are configured to obtain positioning data by measuring multiple positions of an aerial vehicle that is flying. The processor or circuitry is further configured to acquire pieces of positioning data from the positioning data of the aerial vehicle obtained by the first surveying apparatus and from the positioning data of the aerial vehicle obtained by the second surveying apparatus. These pieces of positioning data are measured at times closest to each other. The processor or circuitry is further configured to calculate at least one of a position and an attitude of the second surveying apparatus based on the pieces of positioning data being measured at times closest to each other.

In one aspect of the present invention, the pieces of positioning data being measured at times closest to each other may be the following data: data of the position of the aerial vehicle that is measured at time Tn by one of the first surveying apparatus and the second surveying apparatus, and data of the position of the aerial vehicle that is measured at a time immediately before and/or immediately after the time Tn by the other one of the first surveying apparatus and the second surveying apparatus.

In one aspect of the present invention, assuming that the position of the aerial vehicle that is measured at the time Tn by the one of the first surveying apparatus and the second surveying apparatus is represented as Pn, times when the other one of the first surveying apparatus and the second surveying apparatus measures the position of the aerial vehicle, immediately before and immediately after the time Tn, are represented as Tn1 and Tn2, the position of the aerial vehicle that is measured at the time Tn1 by the other one of the first surveying apparatus and the second surveying apparatus is represented as Pn1, and the position of the aerial vehicle that is measured at the time Tn2 by the other one of the first surveying apparatus and the second surveying apparatus is represented as Pn2, the position Pn may be calculated based on the positions Pn1 and Pn2.

In one aspect of the present invention, the position Pn may be calculated from a path from the position Pn1 to the position Pn2. In one aspect of the present invention, the position Pn may be calculated based on a path that fits to the positions Pn1 and Pn2.

In one aspect of the present invention, assuming that a distance between the positions Pn1 and Pn2 is represented as D1, and a distance between the positions Pn1 and Pn is represented as D, the position Pn may be calculated as a position separated from the position Pn1 in a direction toward the position Pn2 by the distance D, and the distance D may be calculated from a formula D=D1×(Tn−Tn1)/(Tn2−Tn1).

In one aspect of the present invention, the time Tn may be obtained from a period during which the aerial vehicle flies straight, the aerial vehicle may be repeatedly positioned by the first surveying apparatus, and the period during which the aerial vehicle flies straight may be detected based on the positioning that is repeatedly performed on the aerial vehicle by the first surveying apparatus. In one aspect of the present invention, the aerial vehicle may be configured to output a synchronous signal to both of the first surveying apparatus and the second surveying apparatus.

Another aspect of the present invention provides a surveying data processing method including receiving positioning data that is obtained by a first surveying apparatus in which exterior orientation parameters are known, and receiving positioning data that is obtained by a second surveying apparatus in which exterior orientation parameters are unknown. The first surveying apparatus and the second surveying apparatus are configured to obtain positioning data by measuring multiple positions of an aerial vehicle that is flying. The method also includes acquiring pieces of positioning data from the positioning data of the aerial vehicle obtained by the first surveying apparatus and from the positioning data of the aerial vehicle obtained by the second surveying apparatus. These pieces of positioning data are measured at times closest to each other. The method further includes calculating at least one of a position and an attitude of the second surveying apparatus based on the pieces of positioning data being measured at times closest to each other.

Still another aspect of the present invention provides a non-transitory computer recording medium storing computer executable instructions for processing surveying data. The computer executable instructions are made to, when executed by a computer processor, cause the computer processor to receive positioning data that is obtained by a first surveying apparatus in which exterior orientation parameters are known, and receive positioning data that is obtained by a second surveying apparatus in which exterior orientation parameters are unknown. The first surveying apparatus and the second surveying apparatus are configured to obtain positioning data by measuring multiple positions of an aerial vehicle that is flying. The computer executable instructions are also made to, when executed by the computer processor, cause the computer processor to acquire pieces of positioning data from the positioning data of the aerial vehicle obtained by the first surveying apparatus and from the positioning data of the aerial vehicle obtained by the second surveying apparatus. These pieces of positioning data are measured at times closest to each other. The computer executable instructions are also made to, when executed by the computer processor, cause the computer processor to calculate at least one of a position and an attitude of the second surveying apparatus based on the pieces of positioning data being measured at times closest to each other.

Yet another aspect of the present invention provides a surveying data processor including a processor or circuitry. The processor or circuitry is configured to receive positioning data that is obtained by a first surveying apparatus in which exterior orientation parameters are known, and receive positioning data that is obtained by a second surveying apparatus in which exterior orientation parameters are unknown. The first surveying apparatus and the second surveying apparatus are configured to obtain positioning data by measuring multiple positions of an aerial vehicle that is flying. The processor or circuitry is further configured to acquire pieces of positioning data from the positioning data of the aerial vehicle obtained by the first surveying apparatus and from the positioning data of the aerial vehicle obtained by the second surveying apparatus. These pieces of positioning data are measured at times different from each other by a predetermined degree or less, or are separated from each other by a predetermined distance or less. The processor or circuitry is further configured to calculate at least one of a position and an attitude of the second surveying apparatus based on the pieces of positioning data being measured at times different from each other by a predetermined degree or less, or being separated from each other by a predetermined distance or less. This invention can also be viewed as an invention of a method or an invention of a program.

Yet another aspect of the present invention provides a surveying data processor including a processor or circuitry. The processor or circuitry is configured to receive positioning data that is obtained by a first surveying apparatus in which exterior orientation parameters are known, and to receive positioning data that is obtained by a second surveying apparatus in which exterior orientation parameters are unknown. The first surveying apparatus and the second surveying apparatus are configured to obtain positioning data by measuring multiple positions of an aerial vehicle that is flying. The processor or circuitry is further configured to acquire pieces of positioning data from the positioning data of the aerial vehicle obtained by the first surveying apparatus and from the positioning data of the aerial vehicle obtained by the second surveying apparatus. These pieces of positioning data are in a specific relationship. The processor or circuitry is further configured to calculate at least one of a position and an attitude of the second surveying apparatus based on the pieces of positioning data being in the specific relationship. The pieces of positioning data being in the specific relationship are data of the position of the aerial vehicle that is measured at a time Tn by one of the first surveying apparatus and the second surveying apparatus, and data of the position of the aerial vehicle that is measured at a time before and a time after the time Tn by the other one of the first surveying apparatus and the second surveying apparatus. This invention can also be viewed as an invention of a method or an invention of a program.

The present invention enables more simply and easily acquiring information of an instrument point of a surveying apparatus.

### BRIEF DESCRIPTION OF DRAWINGS

FIG. 1 is a schematic diagram of embodiments.

FIGS. 2A and 2B show the external appearance of a surveying apparatus.

FIG. 3 is a block diagram of the surveying apparatus.

FIG. 4 is a block diagram of a data processor.

FIG. 5 is a flowchart showing an example of a processing procedure.

FIG. 6 is a flowchart showing an example of a processing procedure.

FIG. 7 shows examples of positioning data.

FIG. 8 is a principle diagram of a method of resection.

FIG. 9 is a conceptual diagram showing relationships between positioning times and pieces of positioning data in a three-dimensional space.

### DETAILED DESCRIPTION

### 1. First Embodiment (Overview)

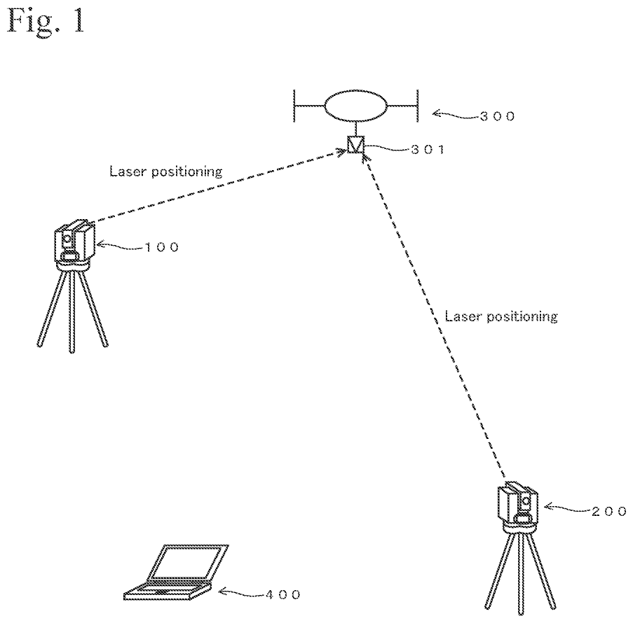

FIG. 1 shows a surveying apparatus 100, a surveying apparatus 200, an unmanned aerial vehicle (UAV) 300, a data processor 400. Details of each apparatus will be described later.

In this example, exterior orientation parameters (position and attitude) of the surveying apparatus 100 are known, but exterior orientation parameters of the surveying apparatus 200 are unknown. The surveying apparatuses 100 and 200 measure positions of the UAV 300 that is flying.

Assuming that the measured multiple positions of the UAV 300 are reference points (control points), the position (instrument point) of the surveying apparatus 200 is calculated by a method of resection. This process is performed by the data processor 400.

This technique makes it possible to obtain an instrument point of the surveying apparatus 200, that is, determine a set-up position of the surveying apparatus 200, although the position of the surveying apparatus 200 is difficult to directly measure by using the surveying apparatus 100 due to presence of mountains, trees, buildings, or other obstructing objects between the surveying apparatuses 100 and 200.

It is necessary for the surveying apparatus 200 to measure positions of the UAV 300 that is flying, but directly measuring the position of the surveying apparatus 200 is not required. Thus, information of the instrument point of the surveying apparatus 200 is more simply and easily acquired.

Each of the number of surveying apparatuses at known positions and the number of surveying apparatuses at unknown positions is not limited to one and may be multiple. Similarly, the number of UAVs 300 is not limited to one, and two or more UAVs 300 may be used.

### Surveying Apparatuses

Each of the surveying apparatuses 100 and 200 is a total station and has a function of measuring a distance and a position by using laser light and of capturing and tracking a target to be surveyed. Each of the surveying apparatuses 100 and 200 can use a total station that is commercially available from a surveying instrument manufacturer.

Herein, the same type of apparatuses are used as the surveying apparatuses 100 and 200. The surveying apparatuses 100 and 200 may be different kinds or models from each other on the condition that they have the functions as described below. It is also possible to use a total station for one of the surveying apparatuses 100 and 200 and a laser scanner for the other in combination.

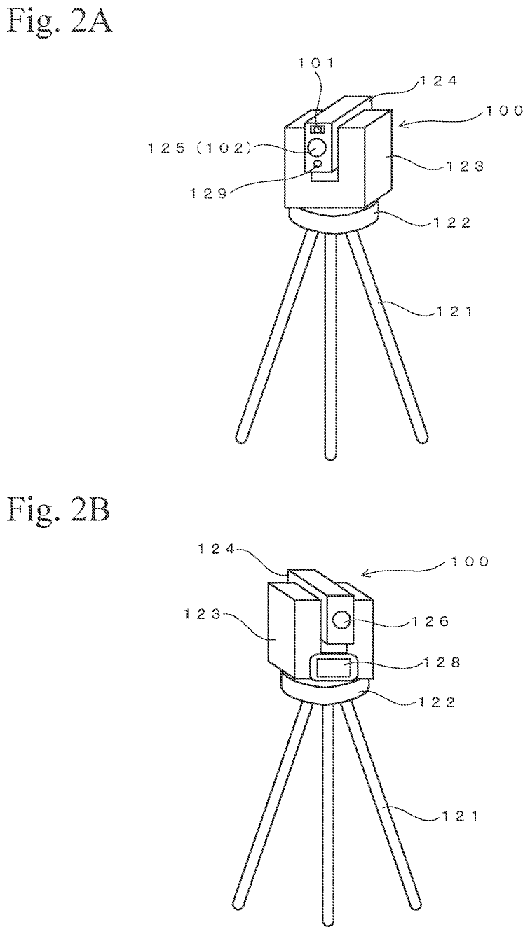

In this example, the surveying apparatuses 100 and 200 are of the same type, and therefore, the following describes the surveying apparatus 100 as an example. FIGS. 2A and 2B are perspective views of the surveying apparatus 100. FIG. 2A is a front perspective view, and FIG. 2B is a back perspective view.

The surveying apparatus 100 includes a base 122 that is fixed on a tripod 121, a horizontal rotation unit 123 that is horizontally rotatable on the base 122, and a vertical rotation unit 124 that is held by the horizontal rotation unit 123, in a state of being vertically rotatable (being controllable in elevation angle and depression angle).

Horizontal rotation and vertical rotation are performed by motors. Each of the horizontal angle of the horizontal rotation unit 123 (oriented direction in the horizontal direction of an optical axis of a telescope 125) and a vertical angle of the vertical rotation unit 124 (elevation angle or depression angle of the optical axis of the telescope 125) is accurately measured by an encoder.

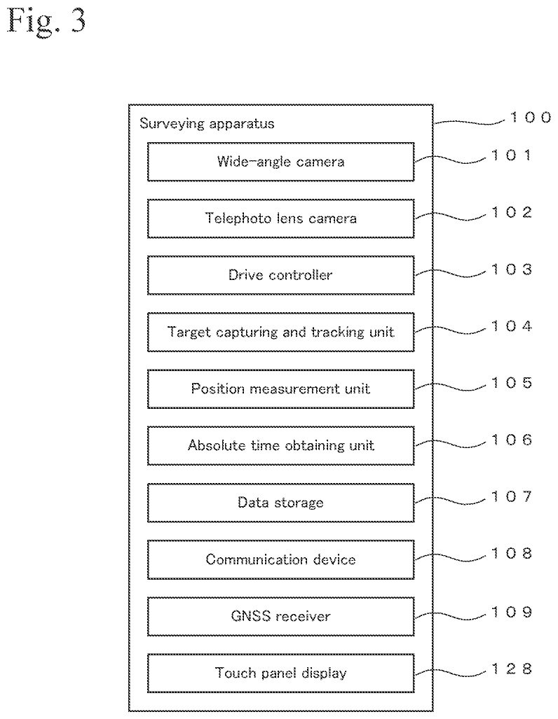

The vertical rotation unit 124 includes a telescope 125, an optical unit 129 of laser light for capturing and tracking, and a wide-angle camera 101, on a front side thereof, and it includes an eyepiece 126 of the telescope 125 and a touch panel display 128, on a back side thereof The telescope 125 also serves as an optical system of a telephoto lens camera 102 shown in FIG. 3.

The telescope 125 also has an objective lens through which distance measuring laser light for measuring a distance (distance measuring light) is emitted to the outside and through which the emitted light that is reflected back is received. That is, the optical axis of the telescope 125 (optical axis of the telephoto lens camera 102) and the optical axis of the distance measuring light are set on the same axial line. In addition, both of the optical axis of the wide-angle camera 101 and the optical axis of the optical unit 129 of the laser light for capturing and tracking are set in the same direction as the optical axis of the telescope 125.

The touch panel display 128 is an operation panel and a display of the surveying apparatus 100. The touch panel display 128 shows various information related to operation of the surveying apparatus 100 and information related to surveying result.

### Block Diagram of Surveying Apparatus

FIG. 3 is a functional block diagram of the surveying apparatus 100. The surveying apparatus 100 includes a wide-angle camera 101, a telephoto lens camera 102, a drive controller 103, a target capturing and tracking unit 104, a position measurement unit 105, an absolute time obtaining unit 106, a data storage 107, a communication device 108, a GNSS receiver 109, and a touch panel display 128.

The wide-angle camera 101 obtains wide-angle photographic images. The telephoto lens camera 102 obtains telephoto images. The drive controller 103 controls the direction of the optical axis of the surveying apparatus 100 (optical axis of the telescope 125). Specifically, the drive controller 103 controls horizontal rotation of the horizontal rotation unit 123 and vertical rotation of the vertical rotation unit 124.

The target capturing and tracking unit 104 performs processes related to capturing and tracking of a target by using laser light for capturing and tracking. The target is a reflector, such as a reflection prism. In this example, the target is a reflection prism 301 that is mounted on the UAV 300.

The laser light for capturing and tracking has a fanning-out beam shape. The direction of the target is searched for by detecting this laser light after it is reflected back from the target. At the time of searching, the direction of the optical axis of the surveying apparatus 100 is finely adjusted under control of the drive controller 103. Specifically, the optical axis is finely adjusted in such a manner as to swing vertically and horizontally, in searching for the target. Details of this technique are disclosed in, for example, Japanese Unexamined Patent Application Publication No. 2009-229192.

As a result of searching, the target is captured on the optical axis of the surveying apparatus 100 (optical axis of the telescope 125). This condition is the state of capturing the target. After the target is captured once, the optical axis of the surveying apparatus 100 is controlled in real time so as to maintain this state. This results in tracking the target. Thus, although the target moves, the direction of the optical axis is controlled following the direction of the target, whereby the state of capturing the target is maintained.

In the case of losing sight of the target in the state of having captured the target, searching for the target is started. In this manner, the control is performed so as to maintain the captured state of the target as much as possible.

The position measurement unit 105 measures a position by using laser light. The position is measured based on a distance to an object (in this case, a reflection prism being a target) measured by distance measuring light (laser light for measuring a distance) and on a direction of the optical axis of the distance measuring light. The distance is calculated by using the principle of electro-optical distance measurement. The distance can be calculated by a method using a phase difference or a propagation time of the distance measuring light that is received. In this example, the distance is measured by the method using a phase difference.

In the method using a phase difference, a reference optical path is provided in a surveying apparatus, and a distance to an object is calculated from a difference (phase difference) between the timing of receiving the distance measuring light that has propagated through the reference optical path and the timing of receiving the distance measuring light that has reflected back from the object. In the method using a propagation time, a distance to an object is calculated from the time it takes for the distance measuring light to reach the object and be reflected back.

The direction of a distance measurement point as seen from the surveying apparatus 100 (direction of the optical axis of the distance measuring light) is obtained by measuring a rotation angle of each of the horizontal rotation unit 123 and the vertical rotation unit 124. The rotation angle of each of the horizontal rotation unit 123 and the vertical rotation unit 124 is accurately measured by an encoder.

The absolute time obtaining unit 106 is a highly accurate electronic clock and obtains an absolute time based on a navigation signal that the GNSS receiver 109 receives from a navigation satellite. For example, Coordinated Universal Time (UTC) is used as the absolute time. Any kind of clock that has an accurate clocking function can also be used.

The data storage 107 stores data and programs necessary to operate the surveying apparatus 100 and data of results of surveying. The communication device 108 communicates with other devices. The communication is made through a telephone line, a wireless LAN line, or a wired line.

The GNSS receiver 109 receives a navigation signal that is used in a GNSS, from a navigation satellite. On the basis of time information contained in the navigation signal, the absolute time obtaining unit 106 obtains an absolute time.

### Block Diagram of Data Processor

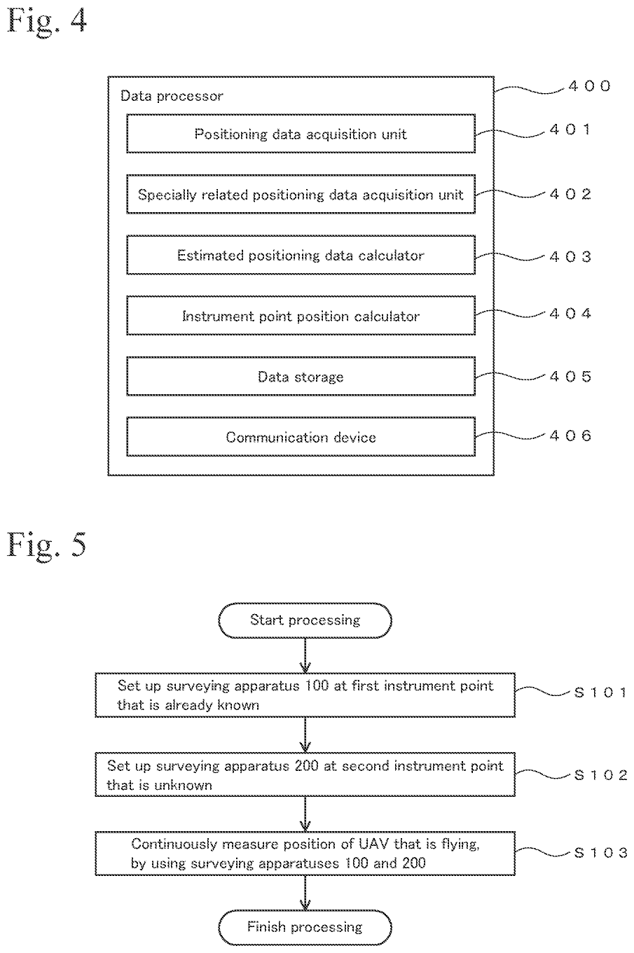

In this example, the data processor 400 is constructed by using a personal computer (PC). The PC is installed with application software for implementing functional units shown in FIG. 4, thereby constituting the data processor 400. One or more, or all of the functional units shown in FIG. 4 may be implemented by dedicated hardware. The functions of the data processor 400 can also be implemented on a server that is connected with the Internet line.

The data processor 400 includes a positioning data acquisition unit 401, a specially related positioning data acquisition unit 402, an estimated positioning data calculator 403, an instrument point position calculator 404, a data storage 405, and a communication device 406.

The positioning data acquisition unit 401 performs the process in step S111, which will be described later. This process acquires pieces of positioning data that are results of measuring positions of the UAV 300 by the surveying apparatuses 100 and 200. The surveying apparatuses 100 and 200 transmit the positioning data to the data processor 400 by using a wireless LAN line, and these pieces of positioning data are received by the positioning data acquisition unit 401.

The specially related positioning data acquisition unit 402 performs the processes in steps S113 and S114, which will be described later. These processes acquire positioning data of the UAV 300. Specifically, these processes acquire pieces of positioning data that are measured at times closest to each other, respectively, from positioning data measured by the surveying apparatus 100 and positioning data measured by the surveying apparatus 200. The processes performed by the specially related positioning data acquisition unit 402 will be detailed in the descriptions for steps S113 and S114.

The estimated positioning data calculator 403 performs the process in step S115, which will be described later. This process calculates estimated positioning data based on the positioning data from the other surveying apparatus, corresponding to positioning data of the UAV 300 from one of the surveying apparatuses.

The surveying apparatuses 100 and 200 do not measure a position of the UAV 300 at the same time, in some cases. In such a situation, the positioning times of the surveying apparatuses 100 and 200 differ from each other, and thus, it is necessary to acquire positioning data that is estimated to be obtained at the same positioning time.

This positioning data that is estimated to be obtained at the same positioning data is estimated positioning data. The process related to this calculation is performed by the estimated positioning data calculator 403. There are two patterns for the estimated positioning data: estimated positioning data that is estimated to be obtained by the surveying apparatus 100, based on the surveying apparatus 200, and estimated positioning data that is estimated to be obtained by the surveying apparatus 200, based on the surveying apparatus 100. The process will be detailed in relation to the description in step S115, described later.

The instrument point position calculator 404 performs the process in step S117. This process calculates a position and an attitude of the surveying apparatus 200 that is at an unknown position in the initial stage, by using a method of resection. The process will be detailed in relation to the description in step S117, described later.

The data storage 405 stores data and operation programs necessary to operate the data processor 400, data processed by the data processor 400, etc. The communication device 406 communicates with an external device. The communication device 406 is used to communicate with each of the surveying apparatuses 100 and 200, for example. The communication is made through a wireless LAN line, a telephone line, or a wired line.

### UAV

The UAV 300 includes a reflection prism 301 that is used as a target to be positioned. The reflection prism 301 reflects incident distance measuring light (positioning light) in a direction inverted by 180 degrees. Each type of reflector, such as a retroreflective target, can be used instead of the reflection prism.

The surveying apparatuses 100 and 200 measure a position of the UAV 300 by targeting the reflection prism 301. Thus, the position of the UAV 300 is understood as the position of the reflection prism 301.

The UAV 300 may be an autonomous flight type or an operator controlled type. In this example, high accuracy to a flightpath of the UAV is not required, and a large mounting capacity is also not required due to a mounted component being the reflection prism. In one example, an inexpensively available toy drone may be used as the UAV 300.

### Example of Preparation Operation

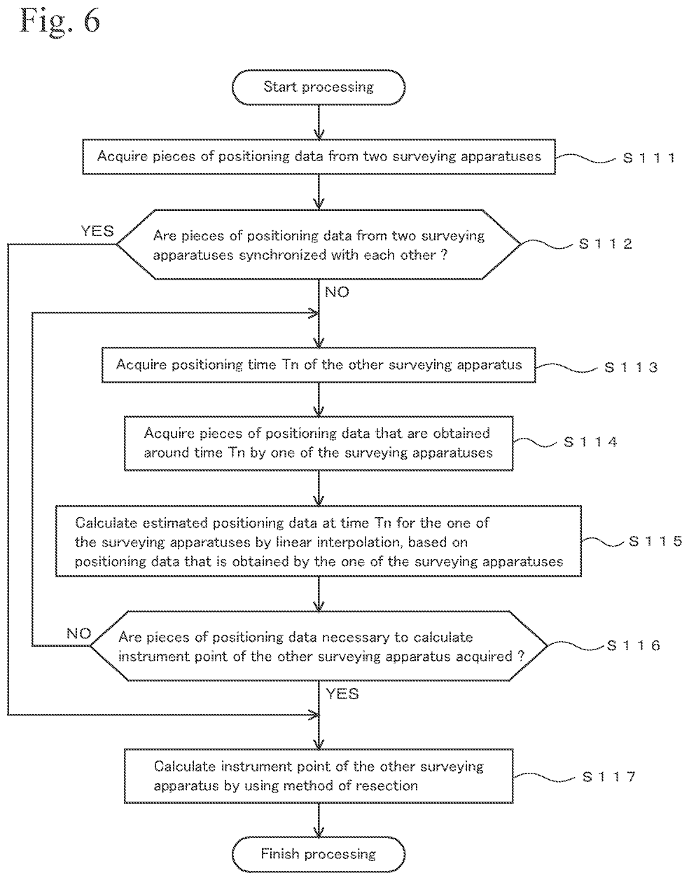

FIGS. 5 and 6 show examples of processing procedures. FIG. 6 shows processing related to calculation of a position (instrument point) of the surveying apparatus 200. FIG. 5 shows a procedure of operation prior to the calculation processing.

First, details of FIG. 5 will be described. As preparation, the surveying apparatus 100 is set up at a first instrument point as a first surveying apparatus (step S101). At this point of time, the exterior orientation parameters (position and attitude) of the surveying apparatus 100 at the first instrument point are preliminarily obtained and are already known. In short, the position (coordinates) of the first instrument point is already known.

The coordinate system uses an absolute coordinate system (global coordinate system). The absolute coordinate system is a coordinate system that is used in a map and in a GNSS. The position in the absolute coordinate system is described in terms of longitude, latitude, and elevation.

Moreover, the surveying apparatus 200 is set up at a second instrument point as a second surveying apparatus (step S102). At this point of time, the exterior orientation parameters (position and attitude) of the surveying apparatus 200 at the second instrument point are unknown. In short, the position (coordinates) of the second instrument point is unknown.

After the surveying apparatuses 100 and 200 are set up, the UAV 300 is made to fly in an airspace that can be seen from both surveying apparatuses 100 and 200. This UAV 300 that is flying is continuously positioned by the surveying apparatuses 100 and 200 (step S103).

The flight of the UAV 300 is controlled by an operator or is performed along a predetermined flightpath. An airspace that can be seen from both of the surveying apparatuses 100 and 200 is selected for the flightpath.

The surveying apparatuses 100 and 200 continuously measure a position of the UAV 300 in a repeated manner. This position measurement is performed at a repetition frequency of approximately 1 to 20 Hz.

The obtained positioning data includes data of a distance from the surveying apparatus to the UAV 300 that is measured by using distance measuring light, and data of a direction of the optical axis of the distance measuring light (data of direction of the UAV 300 as seen from the surveying apparatus). This applies to each of the surveying apparatuses 100 and 200.

The direction of the optical axis of the distance measuring light is obtained in terms of data of a horizontal rotation angle of the horizontal rotation unit 123 and a vertical angle (elevation angle or depression angle) of the vertical rotation unit 124.

The positioning data is obtained in the state of being associated with absolute time that is measured by each surveying apparatus. The pieces of positioning data of the UAV 300 that are obtained by the surveying apparatuses 100 and 200 are processed by the data processor 400. In this example, after a necessary amount of positioning data is obtained, it is transmitted to the data processor 400 and is subjected to processing. The processing of the data may be performed in parallel to position measurement.

### Example of Processing Procedure

FIG. 6 is a flowchart showing a procedure of processing performed by the data processor 400. The program for executing the processing in FIG. 6 is stored in an appropriate storage medium and is executed by a CPU of the computer that constitutes the data processor 400. The program for executing the processing in FIG. 6 may be stored in a server and may be downloaded for use.

After the processing starts, first, positioning data of the UAV 300 obtained by the surveying apparatus 100 and positioning data of the UAV 300 obtained by the surveying apparatus 200 are acquired (step S111).

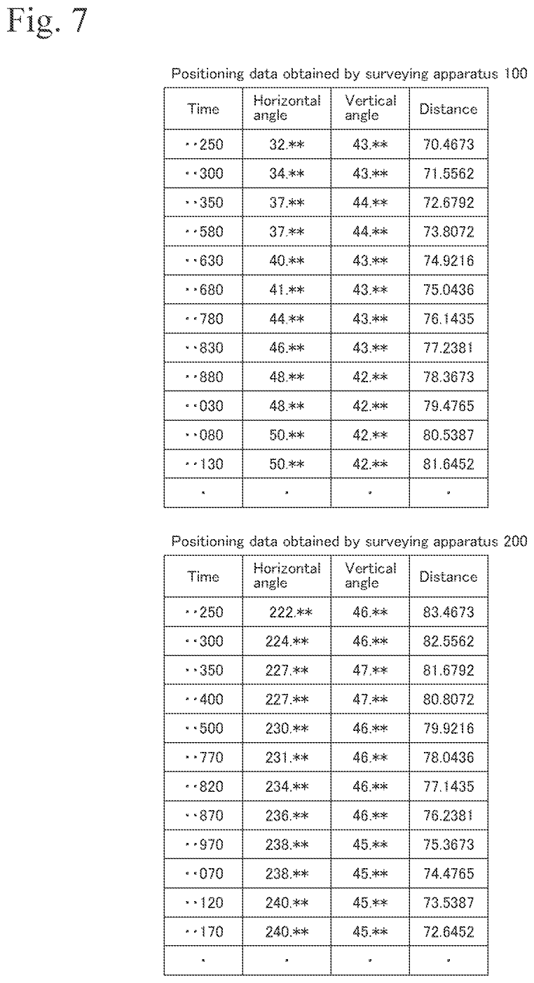

FIG. 7 shows examples of pieces of positioning data. FIG. 7 shows a positioning time that is a time of receiving distance measuring light reflected back from the UAV 300. Data of the direction (horizontal angle and vertical angle) of the optical axis of the surveying apparatus is obtained at the time of receiving the distance measuring light that is reflected back.

FIG. 7 shows an example of positioning data of the UAV 300 that is obtained by the surveying apparatus 100 and an example of positioning data of the UAV 300 that is obtained by the surveying apparatus 200. In the example in FIG. 7, the positioning times of these apparatuses do not agree with each other and are not obtained at the same intervals. The reason for this is described below.

The surveying apparatus 100 (as in the case of the surveying apparatus 200) measures a position of a target that is the reflection prism 301 of the UAV 300. During the positioning, the reflection prism 301 is captured by the target searching function, and the direction of the optical axis of the surveying apparatus 100, that is, the attitude of the surveying apparatus 100, is controlled in real time in order to maintain the state of capturing the reflection prism 301.

However, the UAV 300 may shake or pitch due to wind or an air current, and interruption of tracking or obstruction of the distance measuring light may occur by birds, leaves, dust, etc., that fly through the optical axis of the distance measuring light. These causes may inhibit performing the positioning (distance measurement) at an intended time. This phenomenon can occur independently in each of the surveying apparatuses 100 and 200. Thus, as shown in FIG. 7, the positioning times of these apparatuses do not agree with each other and are not obtained at equal intervals. Of course, the positioning times of these apparatuses may agree with each other and may have the same intervals, but this situation may not always occur.

FIG. 7 shows a case of performing processing of position measurement, basically per 50 ms (20 Hz). Nevertheless, at the time the processing of the position measurement is not conducted in time due to some reason, the processing is skipped, and the time interval may be 100 ms or 150 ms. In another case, tracking of the reflection prism 301 may fail or may be unstably performed, whereby a next position measurement may not be performed at times that are a multiple of 50 ms. FIG. 7 shows a case in which the positioning times of these apparatuses do not agree with each other and do not have the same intervals due to such causes.

After the two pieces of positioning data are acquired in step S111, the two positioning data (for example, refer to FIG. 7) are compared to each other in order to determine whether the positioning data of the UAV 300 obtained by the surveying apparatus 100 and the positioning data of the UAV 300 obtained by the surveying apparatus 200 are synchronized with each other (step S112).

In the case in which the two positioning data are synchronized with each other, the processing advances to step S117. Otherwise, in the case in which they are not synchronized with each other, the processing advances to step S113. Whether the two positioning data are synchronized with each other is determined by using a predetermined threshold. The threshold is determined in consideration of arithmetic errors and a flight speed of the UAV. In one example, a value in the range of 0.1 to 10 ms is adopted as the threshold.

In the case in which the two positioning data are synchronized with each other (or presumed to be synchronized with each other), the surveying apparatuses 100 and 200 clock absolute times at the same time. Thus, pieces of positioning data containing positions that are measured at times closest to each other, can be acquired without any additional processing, respectively, from the positioning data of the UAV 300 obtained by the surveying apparatus 100 and the positioning data of the UAV 300 obtained by the surveying apparatus 200. In an ideal case, pieces of positioning data that are obtained at the same time are acquired.

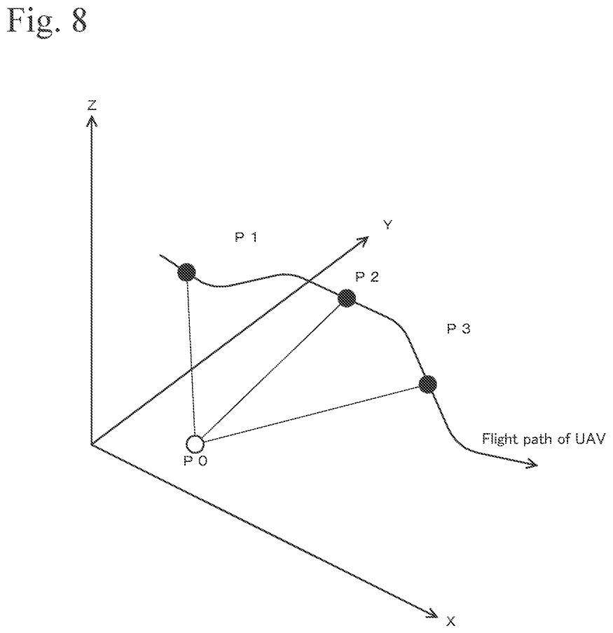

In the case of advancing the processing from step S112 directly to step S117, exterior orientation parameters (position and attitude) of the surveying apparatus 200 are calculated by using a method of resection based on the principle shown in FIG. 8. This process calculates the second instrument point, which is the position of the surveying apparatus 200.

This process uses at least two points of the obtained positions of the UAV 300. FIG. 8 shows a case of using three points, P1, P2, and P3, of the positions of the UAV 300.

In this case, positioning timings of the surveying apparatuses 100 and 200 are synchronized with each other, and P1 to P3 in FIG. 8 are positioned at the same time (or at times that can be presumed to be the same) by the surveying apparatuses 100 and 200. The point P0 is the position (second instrument point) of the surveying apparatus 200. A vector connecting P0 and P1, a vector connecting P0 and P2, and a vector connecting P0 and P3 are obtained from distance values measured by the surveying apparatus 200 and from directions of the optical axis of distance measuring light.

In this case, the positions (coordinate values) in the absolute coordinate system of P1 to P3 are measured by the surveying apparatus 100. Thus, the position in the absolute coordinate system of the point P0, which is a point of intersection of these three vectors, is determined. In addition, the attitude of the surveying apparatus 200 is also determined.

The following describes the case of advancing the processing from step S112 to step S113. In step S113, a time Tn when the UAV 300 was positioned, is acquired from among the positioning data obtained by the surveying apparatus 200. Herein, positioning data of the UAV 300 at the time Tn is not obtained by the surveying apparatus 100. This is because the determination in step S112 results in NO.

Next, positioned points Pn1 and Pn2 of the UAV 300 that are obtained around the time Tn by the surveying apparatus 100, are acquired (step S114). Herein, Pn1 is a position measured by the surveying apparatus 100 and is closest to Pn on the time axis before Pn is obtained, and Pn2 is a position measured by the surveying apparatus 100 and is closest to Pn on the time axis after Pn is obtained.

The surveying apparatuses 100 and 200 use the same absolute time. Thus, positioning times Tn1 and Tn2 that are adjacent to each other across the time Tn, of the UAV 300 obtained by the surveying apparatus 100, can be known.

Herein, Tn1<Tn<Tn2. In this case, the position of the UAV 300 measured at the time Tn1 by the surveying apparatus 100 is Pn1, and the position of the UAV 300 measured at the time Tn2 by the surveying apparatus 100 is Pn2.

After Pn1 and Pn2 are acquired, estimated positioning data of the UAV 300 at the time Tn is calculated based on the positioning data from the surveying apparatus 100 by linear interpolation (step S115). In other words, although the UAV 300 is not actually positioned at the time Tn by the surveying apparatus 100, an estimated value of the position is represented by using the positioning data obtained by the surveying apparatus 100.

The following describes details of the process in step S115. Herein, it is assumed that the time for a positioned point Pn1 is Tn1, the time for a positioned point Pn2 is Tn2, and the position of the UAV 300 at a time Tn is Pn.

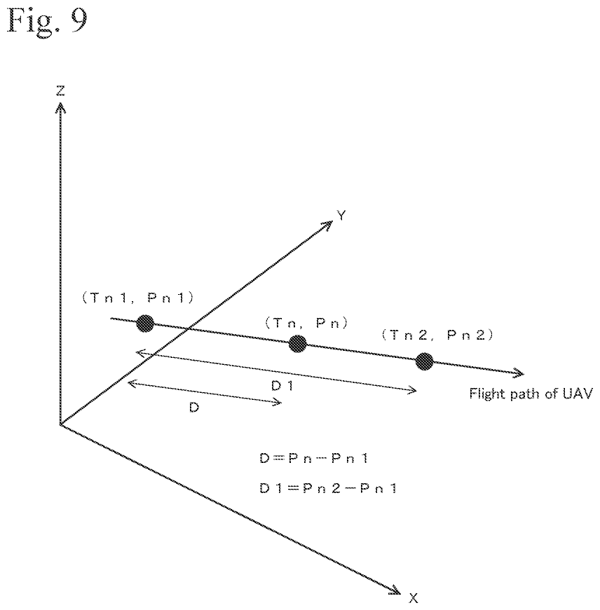

FIG. 9 shows positional relationships between P1, Pn2, and Pn. Specifically, the UAV 300 moves from the position Pn1 to the position Pn2, and the UAV 300 is at the position Pn1 at the time T1, at the position Pn at the time Tn, and at the position Pn2 at the time Tn2.

In this step, the positioning data of the UAV 300 at the time Tn should be acquired based on the positioning data from the surveying apparatus 100. In view of this, assuming that the UAV 300 flies straight at a constant speed between the time Tn1 and the time Tn2, the position of the UAV 300 at the time Tn is estimated based on the positions Pn1 and Pn2 measured by the surveying apparatus 100. That is, the position of the UAV 300 at the time Tn is represented by using Pn1 and Pn2.

Specifically, calculation is performed as follows. First, it is assumed that the UAV 300 moves straight at a constant speed from the position Pn1 to the position Pn2. The time when the UAV 300 is at the position Pn is Tn. The flight under the above-described assumptions from the position Pn1 to the position Pn takes a flight time (Tn−Tn1).

Assuming that the distance between Pn1 and Pn2 is D1 and the distance between Pn1 and Pn is D, Pn is a position separated from Pn1 in the direction toward Pn2 by the distance D. In consideration of the flight at a constant speed, the distance and the flight time are in a direct proportional relationship due to the relationship (Distance=Speed×Time). Thus, a proportional relationship D:D1=(Tn−Tn1):(Tn2−Tn1) is established.

Expanding this proportional relationship provides a relationship D(Tn2−Tn1)=D1(Tn−Tn1), which can be expressed as D=D1(Tn−Tn1)/(Tn2−Tn1). That is, the position of Pn is calculated as a position separated from the position of Pn1 in the direction from Pn1 to Pn2 by the distance D.

In this manner, an estimated position of Pn is calculated by using the positioning data from the surveying apparatus 100 and values of absolute times. This calculation for the estimated position is performed in step S115. This process can also be understood as the following process: a straight line that fits to Pn1 and Pn2 is obtained, this straight line is divided starting from Pn1 by a ratio (Tn−Tn1)/(Tn2−Tn1), and the dividing point is used as an estimated position of Pn based on the positioning data from the surveying apparatus 100.

The processes in steps S113 to S115 acquire pieces of the positioning data that correspond to each other respectively from the positioning data of the UAV 300 obtained by the surveying apparatus 100 and the positioning data of the UAV 300 obtained by the surveying apparatus 200. In this case, the above-described position that is separated in the direction from Pn1 to Pn2 by the distance D is acquired as positioning data based on the positioning data from the surveying apparatus 100, corresponding to the positioning data Pn of the UAV 300 obtained by the surveying apparatus 200.

Next, it is determined whether data of positions of the UAV 300 that are necessary to calculate the set-up position (instrument point) of the surveying apparatus 200 by a method of resection, are already acquired (step S116).

The number of positions of data of the UAV 300 necessary to calculate the set-up position (instrument point) of the surveying apparatus 200 is at least two. Normally, three or more points are desirably acquired. In a case in which the surveying apparatus 200 is horizontally set up at an unknown point, the method of resection can be used, even there are only two points as data of the positions of the UAV 300. In this case, the arithmetic error is smallest in the condition in which an opening angle between the two points is 90 degrees and distances to the two points are the same. As the opening angle approaches 0 or 180 degrees, the arithmetic error becomes large.

The same applies to the case of selecting three or more points. The positions of the UAV 300 are selected such that, as seen from the surveying apparatus 200, two points have an angle therebetween as close to 90 degrees as possible, and they have distances from the surveying apparatus 200 as equal to each other as possible. This increases accuracy of calculating the instrument point of the surveying apparatus 200. The position of the UAV 300 can be freely selected, and this point is convenient.

Specifically, the position data of the UAV 300 to be determined in step S116 preferably contains positions that are at approximately 45 degrees in elevation angle as seen from both of the surveying apparatuses 100 and 200 and that have an opening angle in a right-left direction of approximately 90 degrees. Satisfying these conditions increases accuracy of calculating the set-up position (instrument point) of the surveying apparatus 200 by a method of resection.

In the case in which it is still not possible to acquire positioning data that are required in the process in step S117, in step S116, the processes in step S113 and the subsequent steps are repeated. Note that, in a second or subsequent process in step S113, a value that is different from before is selected for Tn. This selection enables acquiring a position that is different from previously selected positions, as estimated positioning data calculated in step S115.

In the case of having already acquired positioning data that are required in the process in step S117, in step S116, the processing advances to step S117, and the set-up position (instrument point) of the surveying apparatus 200 is calculated by a method of resection.

The following describes the process in step S117 in the case of advancing the processing from step S116 to step S117. In this case, P1 to P3 in FIG. 8 represent positions of the UAV 300 measured by the surveying apparatus 200. The point P0 is a position of the surveying apparatus 200.

A vector connecting P0 and P1, a vector connecting P0 and P2, and a vector connecting P0 and P3 are obtained from distance values measured by the surveying apparatus 200 and from directions of the optical axis of distance measuring light.

On the other hand, P1 to P3 are not directly positioned by the surveying apparatus 100, but P1 to P3 are calculated in step S115, as estimated positioning data based on the data of positions of the UAV 300 measured by the surveying apparatus 100.

That is, P1 to P3 are obtained as estimated positioning data that are represented by using the positioning data obtained by the surveying apparatus 100. Herein, pieces of the positioning data that are obtained by the surveying apparatus 100 are positioning values in the absolute coordinate system.

Thus, the position in the absolute coordinate system of the point P0, which is a point of intersection of the three vectors, is determined. In addition, the directions of P1 to P3 as seen from the surveying apparatus 200 are determined, whereby the attitude of the surveying apparatus 200 is also determined. In this manner, the position and the attitude of the surveying apparatus 200 are calculated based on pieces of the positioning data that correspond to each other between the positioning data obtained by the surveying apparatus 100 and the positioning data obtained by the surveying apparatus 200. The above-described process is performed in step S117 in the case of advancing the processing from step S116 to step S117.

### Advantageous Effects

In the case of using the surveying apparatus 100 in which exterior orientation parameters are already known and the surveying apparatus 200 in which exterior orientation parameters are unknown, although the surveying apparatus 200 cannot be seen from the surveying apparatus 100 due to hills, mountains, forests, buildings, or the like, which are present therebetween, exterior orientation parameters of the surveying apparatus 200 can be determined. The UAV 300 is not required to have high autonomous flight performance. For this reason, an inexpensively available toy drone can be used. In addition, advanced technology is not required in flight control of the UAV 300.

For example, the present invention can be implemented as follows: while the UAV 300 is made to fly so as to circle in an airspace seen from both of the surveying apparatuses 100 and 200, the UAV 300 is tracked and is positioned successively in a continuous manner by the surveying apparatuses 100 and 200, and obtained data is analyzed thereafter. This operation is simple and easy and can reduce a workload of a worker.

### 2. Second Embodiment

In this example, in step S113 in FIG. 6, the time Tn when the first surveying apparatus 100 measured the position of the UAV 300 is acquired. In step S114, pieces of positioning data of the UAV 300 obtained around the time Tn by the surveying apparatus 200 are acquired.

Thus, pieces of positioning data that correspond to each other are acquired respectively from the positioning data of the UAV 300 obtained by the surveying apparatus 100 and the positioning data of the UAV 300 obtained by the surveying apparatus 200.

In step S115, estimated positioning data of the UAV 300 at the time Tn is acquired by linear interpolation, based on data from the second surveying apparatus 200. Thus, the position of the surveying apparatus 200 is calculated based on the pieces of the positioning data that correspond to each other. Other processes are the same as those in FIG. 6.

### 3. Third Embodiment

The present invention can be applied in a case of using three or more surveying apparatuses. In this case, an instrument point of a first surveying apparatus is already known, an instrument point of a second surveying apparatus is unknown, an instrument point of a third surveying apparatus is unknown, . . . , and an instrument point of an Nth surveying apparatus is unknown. Note that the symbol “N” is a natural number of three or greater.

The procedure includes performing the processing in FIG. 6 for the pair of the first surveying apparatus and the second surveying apparatus and acquiring an instrument point of the second surveying apparatus. On the other hand, the processing in FIG. 6 is performed also for the pair of the first surveying apparatus and the third surveying apparatus, and an instrument point of the third surveying apparatus is acquired. Finally, an instrument point of the Nth surveying apparatus is acquired in a similar manner.

In this case, the UAV is controlled so as to fly in an airspace that can be seen from both the first surveying apparatus and the second surveying apparatus, fly in an airspace that can be seen from both the first surveying apparatus and the third surveying apparatus, . . . , and fly in an airspace that can be seen from both the first surveying apparatus and the Nth surveying apparatus.

In another method, first, the processing in FIG. 6 is performed for the pair of the first surveying apparatus and the second surveying apparatus, and an instrument point of the second surveying apparatus is acquired. Then, the processing in FIG. 6 is performed also for the pair of the second surveying apparatus, in which the instrument point has been already known, and the third surveying apparatus, in which the instrument point is still unknown, and an instrument point of the third surveying apparatus is acquired. Finally, in a similar manner, the processing in FIG. 6 is performed also for the pair of the (N−1)th surveying apparatus, in which the instrument point has been already known, and the Nth surveying apparatus, in which the instrument point is still unknown, and an instrument point of the Nth surveying apparatus is acquired.

In this case, the UAV is controlled so as to fly in an airspace that can be seen from both the first surveying apparatus and the second surveying apparatus, fly in an airspace that can be seen from both the second surveying apparatus and the third surveying apparatus, . . . , and fly in an airspace that can be seen from both the (N−1)th surveying apparatus and the Nth surveying apparatus.

Even in a case of using two or more surveying apparatuses that require acquisition of an instrument point (exterior orientation parameters), the amount of work is not increased very much. In this case, after each surveying apparatus is set up, the UAV is made to fly and is positioned by each surveying apparatus, whereby necessary positioning data is obtained. Thereafter, the positioning data that is obtained by each surveying apparatus is post-processed based on the processing in FIG. 6, and thus, the unknown instrument point of each of multiple surveying apparatuses is clarified.

### 4. Fourth Embodiment

In step S115, assuming that the UAV 300 flies straight, the estimated positioning data is calculated by linear interpolation. However, the UAV 300 does not necessarily fly straight. The UAV 300 may move irregularly due to influence of an air current in some cases.

In this embodiment, the period during which the UAV 300 flies straight is determined, and Tn during this period is acquired in step S113. The procedure is described below. In this process, prior to step S113, the period during which the UAV 300 flies straight is found based on the positioning data of the UAV 300 obtained by the surveying apparatus 100.

The surveying apparatus 100 continuously measures a position of the UAV 300 and provides positioning data that contains values in the absolute coordinate system, in associated with the absolute time. Thus, the period during which the flightpath of the UAV 300 is a straight line, can be known from the positioning data obtained by the surveying apparatus 100. The Tn is acquired from among this period, in step S113. This reduces error that may occur in the process in step S115.

The flightpath may be approximated by a circular arc or the like, and interpolation may be performed to obtain estimated positioning data. The function that is used in approximation is not limited to one for a circular arc, and a function for a part of ellipse, an equation of each type of curve, or a function for another curve that fits to the flightpath can also be used.

### 5. Fifth Embodiment

Other methods of synchronizing the surveying apparatuses 100 and 200 will be described. A first method involves transmitting a timing signal that instructs timing of positioning, from the UAV 300, as a synchronization signal. In this case, a positioning instruction signal is transmitted from the UAV 300, as a synchronization signal that instructs positioning. Transmission of the positioning instruction signal is performed by using, for example, a wireless LAN standard.

The surveying apparatuses 100 and 200 successively and continuously capture the UAV 300 that is flying. Upon receiving the positioning instruction signal, the surveying apparatuses 100 and 200 in the state of capturing the UAV 300 measure a position of the UAV 300.

The UAV 300 transmits the positioning instruction signal multiple times while flying. On the condition that the surveying apparatuses 100 and 200 are of the same model number, the speeds of operation in response to the positioning instruction signal are the same, and the positioning processes thereof can be synchronized with each other.

Unfortunately, there may be cases in which at least one of the surveying apparatuses fails to measure a position of the UAV due to effects of birds flying in the sky, or the like. In such cases, pieces of positioning data that are obtained at the same time are selected in post-processing.

An optical signal may be transmitted as the synchronization signal from the UAV 300. In one example, the UAV 300 includes a light-emitting device that periodically emits synchronous light. The surveying apparatuses 100 and 200 photograph the UAV 300 by using respective on-board cameras and then detect the synchronous light in the photographic images. The surveying apparatuses 100 and 200 measure a position of the UAV 300 upon detecting the synchronous light.

### 6. Sixth Embodiment

The absolute time can be obtained by using a reference clock signal that is transmitted from the UAV 300. In relation to the absolute time in the embodiments, the absolute value of time is not important, but it is important that both of the surveying apparatuses 100 and 200 can use the same time and know the timing simultaneously. That is, it is important that the surveying apparatuses 100 and 200 can use clocks that clock the same time with each other.

Thus, a reference signal may be transmitted from the UAV 300 and be received by the surveying apparatuses 100 and 200, and both of the surveying apparatuses may measure the same time as each other.

This example can be implemented by mounting a transmitter that outputs a radio wave clock signal for clocking time, on the UAV 300. The surveying apparatuses 100 and 200 measure a position of the UAV 300 in a visible range, and therefore, the transmitter can be of a small output type.

Alternatively, instead of a radio clock signal, the UAV 300 may output an optical clock signal. In this case, the surveying apparatuses 100 and 200 detect the optical clock signal by using respective on-board cameras, to obtain information of time that is clocked by the optical clock signal.

### 7. Seventh Embodiment

In one example, in the case in FIG. 9, in addition to Tn1 and Tn2, a time Tn0 when the surveying apparatus 100 measures a position of the UAV 300 before Tn1 may be selected. In this example, the positioning data of the UAV 300 at Tn0 obtained by the surveying apparatus 100 is represented as Pn0.

Under these conditions, a flightpath that fits to three points, Pn0, Pn1, and Pn2, is set, and coordinates of a point corresponding to Tn in this flightpath are calculated.

In one example, this flightpath between Pn1 and Pn2 is divided by a ratio (Tn−Tn1)/(Tn2−Tn1), and the dividing point is used as a point corresponding to Pn. Thus, Pn can be represented by using the positioning data from the surveying apparatus 100.

In this case, a time when the surveying apparatus 100 measures a position of the UAV 300 after Tn2 may also be selected, and positioning data Pn3 may also be acquired. Under these conditions, a path that fits to four points of Pn0, Pn1, Pn2, and Pn3 is set as the flightpath of the UAV 300.

In this embodiment, in the case in which the UAV 300 makes a circular flight, this influence can be included in calculation of the estimated positioning data in step S115.

### 8. Eighth Embodiment

In the case in FIG. 9, Pn1 and Pn2 are preferably as close to Pn as possible. This is because a shorter distance between Pn1 and Pn2 increases accuracy of linear interpolation performed in step S115.

In view of this, in this embodiment, first, Pn1 and Pn2 that are adjacent on a spatial axis with a shortest distance therebetween are selected from among the positioning data sequence of the UAV 300 obtained by the surveying apparatus 100. Then, Tn1 corresponding to Pn1 and Tn2 corresponding to Pn2 are acquired.

Next, it is determined whether Tn that satisfies a relationship Tn1<Tn<Tn2 exists. In the case of having Tn that satisfies this determination condition, in other words, if the surveying apparatus 200 measures a position of the UAV 300 between Tn1 and Tn2, the corresponding Tn is selected, and the processes in step S113 and the subsequent steps in FIG. 6 are executed.

In the case of not having Tn that satisfies the relationship Tn1<Tn<Tn2, Pn1 and Pn2 that have a next shortest distance therebetween are selected, and whether Tn that satisfies the relationship Tn1<Tn<Tn2 exists is determined again.

In this embodiment, Pn1 and Pn2 that are as close to Pn as possible are selected, resulting in improving accuracy of the estimated positioning data calculated in step S115.

### 9. Ninth Embodiment

The following describes an example of selecting one piece of positioning data from the positioning data of an aerial vehicle obtained by the first surveying apparatus and acquiring one piece of positioning data from the positioning data of the aerial vehicle obtained by the second surveying apparatus, in which these pieces of positioning data are in a specific relationship.

In this example, only Tn1 is selected as a time related to Tn in FIG. 9. That is, in step S114, a time Tn1 that is a time prior to Tn and close to Tn, is acquired as the positioning time of the UAV 300 obtained by the surveying apparatus 100.

In this case, the following calculation is performed in order to increase accuracy of the estimated positioning data calculated in step S115. First, a velocity vector of the UAV 300 at the time Tn1 is calculated based on the positioning data of the UAV 300 obtained by the surveying apparatus 100. Next, assuming that the flight at this velocity vector is continued from Tn1 to Tn, the position at Tn is calculated as the estimated positioning data.

In this example, instead of Tn1, Tn2 may be acquired. In this case, the position of the UAV 300 at Tn is calculated backward from Tn2, as the estimated positioning data. In more detail, a velocity vector of the UAV 300 at Tn2 is calculated, and on the assumption that this velocity vector is continued from Tn to Tn2, the position of the UAV 300 at Tn is calculated in such a manner as to go back from Pn2 in the flightpath.

### 10. Tenth Embodiment

It is assumed that Tn1 and Tn2 are times when the surveying apparatus 100 measures positions of the UAV 300 and that Tn is a time when the surveying apparatus 200 measures a position of the UAV 300. Under these conditions, Tn1 and Tn2 are selected so as to satisfy the following conditions: a threshold>ΔT1, and a threshold>ΔT2, in which Tn-Tn1=ΔT1, and Tn2−Tn=ΔT2.

In this case, the positioning time Tn of the surveying apparatus 200 and the positioning time Tn1 of the surveying apparatus 100 may not be adjacent to each other on the time axis. That is, the surveying apparatus 100 may measure a position of the UAV 300 between Tn1 and Tn.

In addition, the positioning time Tn of the surveying apparatus 200 and the positioning time Tn2 of the surveying apparatus 100 may not be adjacent to each other on the time axis. That is, the surveying apparatus 100 may measure a position of the UAV 300 between Tn and Tn2.

The thresholds for use in determination of ΔT1 and ΔT2 are selected from values of, for example, 100 ms or less.

In another case, Tn1 (Pn1) and Tn2 (Pn2) may be selected so as to satisfy the following conditions: a threshold>ΔP1, and a threshold>ΔP2, in which Pn−Pn1=ΔP1 and Pn2−Pn=ΔP2.

In this case, the position Pn measured by the surveying apparatus 200 and the position Pn1 measured by the surveying apparatus 100 may not be adjacent to each other. That is, a point that is positioned by the surveying apparatus 100 may exist between Pn and Pn1. In addition, the position Pn measured by the surveying apparatus 200 and the position Pn2 measured by the surveying apparatus 100 may not be adjacent to each other. That is, a point that is positioned by the surveying apparatus 100 may exist between Pn and Pn2. The thresholds are selected from values of, for example, 100 cm or less, preferably 50 cm or less, or more preferably 25 cm or less.

### 11. Eleventh Embodiment

It is assumed that Tn1 and Tn2 are times when the surveying apparatus 100 measures positions of the UAV 300 and that Tn is a time when the surveying apparatus 200 measures a position of the UAV 300. Under these conditions, at least one of Tn1 and Tn2 may not be selected from times closest to Tn.

For example, in the case in which the UAV flies straight at a constant speed, although Tn1 and Tn2 are separated from each other on the time axis, the estimated positioning data is calculated with a small error in step S115. In such a situation, at least one of Tn1 and Tn2 may not be selected from times closest to Tn.

### 12. Twelfth Embodiment

In one case, although the position and the attitude of a first surveying apparatus at a first instrument point are already known, the attitude of a second surveying apparatus at a second instrument point is unknown even though the position of the second surveying apparatus is already known. In this case, the present invention can be used to calculate the attitude of the second surveying apparatus at the second instrument point. This method is generally called a “backsight point method”. The following describes a specific example.

For example, the position of the second instrument point may have already been measured, and thus, a pile may be driven thereat, or a mark may be attached thereat. In this condition, the position of the second surveying apparatus is determined by setting up the second surveying apparatus thereat. However, the position is still unknown.

In this situation, a UAV is made to fly in the air so that it can be seen from both the first surveying apparatus and the second surveying apparatus, and a position of the UAV is measured by the first surveying apparatus and the second surveying apparatus. Data is obtained by using the method disclosed in this specification.

This case requires measurement of only one position of the UAV (of course, two or more positions may be measured). On the condition that a position P of the UAV and a direction of the position P of the UAV as seen from the second surveying apparatus are known, a vector from the second surveying apparatus to the point P is set. The position of the second surveying apparatus is already known, and thus, in response to setting the vector, the attitude of the second surveying apparatus is obtained. The unknown attitude of the second surveying apparatus is clarified in this manner.

In another case, while the position and the attitude of a first surveying apparatus at a first instrument point are already known, the position of a second surveying apparatus at a second instrument point is unknown although the attitude of the second surveying apparatus is already known. In this case, the position of the second surveying apparatus at the second instrument point can be calculated in a similar manner.

### Other Matters

The present invention can also be used in determining the instrument point of a surveying apparatus at an unknown point, with the use of multiple surveying apparatuses at known instrument points. Specifically, a UAV is tracked and is positioned by a first surveying apparatus and a second surveying apparatus at known instrument points and a third surveying apparatus at an unknown instrument point, and these pieces of obtained positioning data are used to determine the instrument point of the third surveying apparatus.

A laser scanner or a total station mounted with a laser scanner can also be used as the surveying apparatus.

What is claimed is:

1. A surveying data processor comprising:
a processor or circuitry configured to:
receive positioning data that is obtained by a first surveying apparatus in which exterior orientation parameters are known, and receive positioning data that is obtained by a second surveying apparatus in which exterior orientation parameters are unknown, the first surveying apparatus and the second surveying apparatus configured to obtain positioning data by measuring multiple positions of an aerial vehicle that is flying;
acquire pieces of positioning data from the positioning data of the aerial vehicle obtained by the first surveying apparatus and from the positioning data of the aerial vehicle obtained by the second surveying apparatus, these pieces of positioning data being measured at times closest to each other; and
calculate at least one of a position and an attitude of the second surveying apparatus based on the pieces of positioning data being measured at times closest to each other.

2. The surveying data processor according to claim 1, wherein the pieces of positioning data being measured at times closest to each other are:
data of the position of the aerial vehicle that is measured at time Tn by one of the first surveying apparatus and the second surveying apparatus, and
data of the position of the aerial vehicle that is measured at a time immediately before and/or immediately after the time Tn by the other one of the first surveying apparatus and the second surveying apparatus.

3. The surveying data processor according to claim 2, wherein, assuming that the position of the aerial vehicle that is measured at the time Tn by the one of the first surveying apparatus and the second surveying apparatus is represented as Pn, times when the other one of the first surveying apparatus and the second surveying apparatus measures the position of the aerial vehicle, immediately before and immediately after the time Tn, are represented as Tn1 and Tn2,
the position of the aerial vehicle that is measured at the time Tn1 by the other one of the first surveying apparatus and the second surveying apparatus is represented as Pn1, and
the position of the aerial vehicle that is measured at the time Tn2 by the other one of the first surveying apparatus and the second surveying apparatus is represented as Pn2,
the position Pn is calculated based on the positions Pn1 and Pn2.

4. The surveying data processor according to claim 3, wherein the position Pn is calculated from a path from the position Pn1 to the position Pn2.

5. The surveying data processor according to claim 3, wherein the position Pn is calculated based on a path that fits to the positions Pn1 and Pn2.

6. The surveying data processor according to claim 3, wherein, assuming that a distance between the positions Pn1 and Pn2 is represented as D1, and
a distance between the positions Pn1 and Pn is represented as D,
the position Pn is calculated as a position separated from the position Pn1 in a direction toward the position Pn2 by the distance D, and
the distance D is calculated from a formula D=D1×(Tn−Tn1)/(Tn2−Tn1).

7. The surveying data processor according to claim 2, wherein the time Tn is obtained from a period during which the aerial vehicle flies straight, the aerial vehicle is repeatedly positioned by the first surveying apparatus, and the period during which the aerial vehicle flies straight is detected based on the positioning that is repeatedly performed on the aerial vehicle by the first surveying apparatus.

8. The surveying data processor according to claim 1, wherein the aerial vehicle is configured to output a synchronous signal to both of the first surveying apparatus and the second surveying apparatus.

9. A surveying data processing method comprising:
receiving positioning data that is obtained by a first surveying apparatus in which exterior orientation parameters are known, and receiving positioning data that is obtained by a second surveying apparatus in which exterior orientation parameters are unknown, the first surveying apparatus and the second surveying apparatus configured to obtain positioning data by measuring multiple positions of an aerial vehicle that is flying;
acquiring pieces of positioning data from the positioning data of the aerial vehicle obtained by the first surveying apparatus and from the positioning data of the aerial vehicle obtained by the second surveying apparatus, these pieces of positioning data being measured at times closest to each other; and
calculating at least one of a position and an attitude of the second surveying apparatus based on the pieces of positioning data being measured at times closest to each other.

10. A non-transitory computer recording medium storing computer executable instructions for processing surveying data, the computer executable instructions made to, when executed by a computer processor, cause the computer processor to:
receive positioning data that is obtained by a first surveying apparatus in which exterior orientation parameters are known, and receive positioning data that is obtained by a second surveying apparatus in which exterior orientation parameters are unknown, the first surveying apparatus and the second surveying apparatus configured to obtain positioning data by measuring multiple positions of an aerial vehicle that is flying;
acquire pieces of positioning data from the positioning data of the aerial vehicle obtained by the first surveying apparatus and from the positioning data of the aerial vehicle obtained by the second surveying apparatus, these pieces of positioning data being measured at times closest to each other; and
calculate at least one of a position and an attitude of the second surveying apparatus based on the pieces of positioning data being measured at times closest to each other.
